(19) United States
(12) Patent Application Publication
(10) Pub. No.: US 2012/0024117 A1
(43) Pub. Date: Feb. 2, 2012

(54) Starter Tool

(76) Inventor: Robert E. Kreutzer, Columbia, IL (US)

(21) Appl. No.: 13/165,351

(22) Filed: Jun. 21, 2011

Related U.S. Application Data
(60) Provisional application No. 61/400,491, filed on Jul. 29, 2010.

(51) Int. Cl. B25B 21/02; B25B 29/00

(52) U.S. Cl. 81/463; 173/90

(57) ABSTRACT

A starter tool for use with a rotatable tool. The starter tool includes a base having a mount adapted to connect to the rotatable tool and a chuck rotatably mounted on the base and adapted to hold a work bit. A punch mechanism operatively connected to the work bit and selectively providing an impact force on the work bit to drive the work bit toward a working surface.

### CROSS REFERENCE TO RELATED APPLICATION

This Application claims priority to U.S. Provisional Patent Application No. 61/400,491 filed Jul. 29, 2010, entitled, “Starter Device for Drills and Fasteners”, which is hereby incorporated by reference in its entirety.

### BACKGROUND

The present invention generally relates to tools such as power and manual tools, and more particularly, to a starter tool or a tool having a starter device providing an axial impact to a work bit for creating a starter dent in a working surface.

Rotatable tools such as screw drivers and drills are frequently used to rotate work bits such as screw driver bits and drill bits. For example, cordless power screw drivers are used to install self tapping screws into a working surface and pistol grip drills are used with drill bits to make holes in a working surface. Depending upon the hardness of the materials on which the tools are used, the work bits tend to drift along the working surface before penetration. Thus, the fastener or hole may be mispositioned. This phenomenon is aggravated when the fastener or drill is driven at an angle other than perpendicular to the working surface. In these situations, the worker may start the fastener or drill perpendicular to the working surface and then tilt the bit once it initially penetrates the working surface. This maneuver slows the operation and has a potential to damage the working surface, the work bit, or the fastener, or to misposition the fastener or hole. Sometimes a tool known as a center punch is used to make a small starter dent in the working surface before the rotatable tool is used. The tip of the fastener or drill bit is positioned in the dent to prevent it from drifting. Center punches may be a simple pointed punch that is struck with a hammer to form the dent in the working surface. Other center punches have a pointed tip and a spring-loaded punching mechanism that impacts the tip when the center punch is pushed against the working surface with a predetermined force to drive the tip into the working surface. Regardless of the type used, center punches slow production due to the need to perform a separate step with a separate tool before the rotatable tool is used.

Thus, there is a need for a starter tool or a tool having a starter device that eliminates the need for using a separate tool to create a starter dent in a working surface.

### SUMMARY

In one aspect, the present invention includes a starter tool for use with a rotatable tool. The starter tool comprises a base having a mount adapted to connect to the rotatable tool. The starter tool also includes a chuck adapted to hold a work bit moveably connected to the base for movement with respect to the base between an extended position, in which the chuck is positioned farther from the mount, and a retracted position, in which the chuck is positioned closer to the mount. The chuck is biased toward the extended position and has an anvil surface. In addition, the starter tool comprises a striker mounted on the base for movement with respect to the chuck between a striking position, in which the striker is closer to the anvil surface, and a loaded position, in which the striker is farther from the anvil surface. The striker is biased toward the striking position. Further, the starter tool comprises a release operatively positioned between the striker and the anvil surface of the chuck permitting the striker to move from the loaded position toward the striking position when the chuck reaches the retracted position thereby allowing the striker to provide an impact force on the anvil surface of the chuck to drive the work bit toward a working surface.

In another aspect, the present invention includes a tool having a housing. A chuck rotatably mounted on the housing is adapted to hold a work bit for rotating the work bit. Further, the tool comprises an anvil surface mounted on the housing. The tool includes a striker moveably mounted on the housing for movement between a striking position, in which the striker is closer to an anvil surface fixed against axial movement with respect to the housing, and a loaded position in which the striker is farther from the anvil surface. A punch mechanism mounted on the housing operatively positioned between striker and the anvil surface selectively drives the striker toward the anvil surface to drive the work bit toward a working surface.

In still another aspect, the present invention includes a starter tool selectively connectible to a rotatable tool. The starter tool comprises a base having a mount adapted to connect to the rotatable tool. The starter tool has a chuck rotatably mounted on the base and adapted to hold a work bit and a punch mechanism operatively connected to the work bit and selectively providing an impact force on the work bit to drive the work bit toward a working surface.

In yet another aspect, the present invention includes a starter tool for use with a rotatable tool. The starter tool comprises a base having a mount adapted to connect to the rotatable tool and a chuck adapted to hold a work bit so the work bit moves with respect to the base between an extended position, in which the work bit is positioned farther from the mount, and a retracted position, in which the work bit is positioned closer to the mount. The work bit is biased toward the extended position. The starter tool also includes a striker mounted on the base for movement with respect to the chuck between a striking position, in which the striker is closer to the chuck, and a loaded position, in which the striker is farther from the chuck. The striker is biased toward the striking position. In addition, the starter tool comprises a release operatively positioned between the striker and the work bit permitting the striker to move from the loaded position toward the striking position when the work bit reaches the retracted position thereby allowing the striker to provide an impact force on the work bit to drive the work bit toward a working surface.

Other aspects of the present invention will be apparent in view of the following description and claims.

### BRIEF DESCRIPTION OF THE DRAWINGS

FIG. 1 is side elevation of a tool including a starter tool of a first embodiment of the present invention holding a work bit for driving a fastener into a working surface;

FIG. 2 is a perspective of the starter tool holding the work bit driving the screw fastener;

FIG. 3 is a cross section of the starter tool taken in a plane of line 3-3 of FIG. 2 showing the starter tool in an initial position;

FIG. 4 is a cross section similar to FIG. 3 but showing the starter tool in a partially compressed position;

FIG. 5 is a cross section similar to FIG. 3 but showing the starter tool in a fully compressed or loaded position;

FIG. 6 is a cross section similar to FIG. 3 but showing the starter tool in a striking position;

FIG. 7 is a cross section of a starter tool of a second embodiment of the present invention;

FIG. 8 is a perspective of a tool of a third embodiment having an internal starter device for creating a starter dent; and

FIG. 9 is a perspective of a tool of a third embodiment in partial cross section.

Corresponding reference characters indicate corresponding parts throughout the drawings.

### DETAILED DESCRIPTION OF THE DRAWINGS

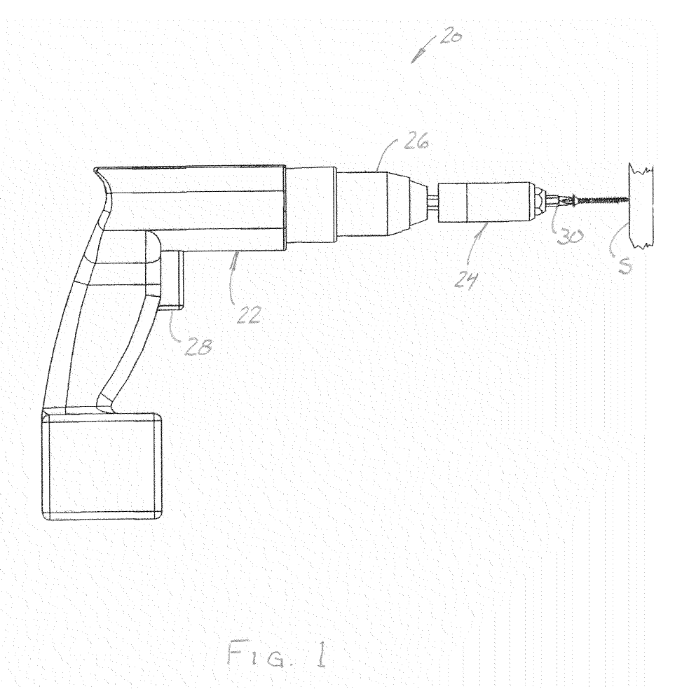

Referring to FIG. 1, a combined tool incorporating a first embodiment of the present invention is designated in its entirety by the reference number 20. The combined tool 20 includes a rotatable tool, generally designated by 22, and a starter tool, generally designated by 24. Although the rotatable tool may be of other types without departing from the scope of the present invention, in one embodiment the rotatable tool 22 is a battery powered, pistol grip, portable electric drill. In other embodiments the tool 22 may have other forms, such as a manual drill or screw driver, an AC powered portable drill, a power screw driver, a hand grinder, a lathe, or a drill press. The rotatable tool 22 includes a chuck 26 for gripping the starter tool 24 and a trigger 28 for energizing the rotatable tool to rotate the chuck about its central axis thereby rotating a work bit 30, such as a screw driver bit or a drill bit, to penetrate a working surface S. As the features of the rotatable tool 22 and the work bit 30 are well known to those skilled in the art, they will not be described in further detail.

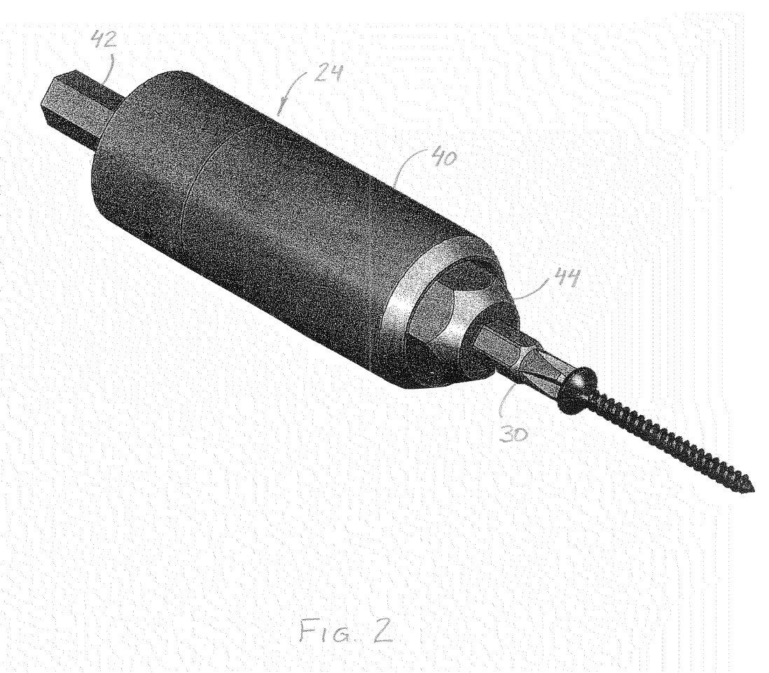

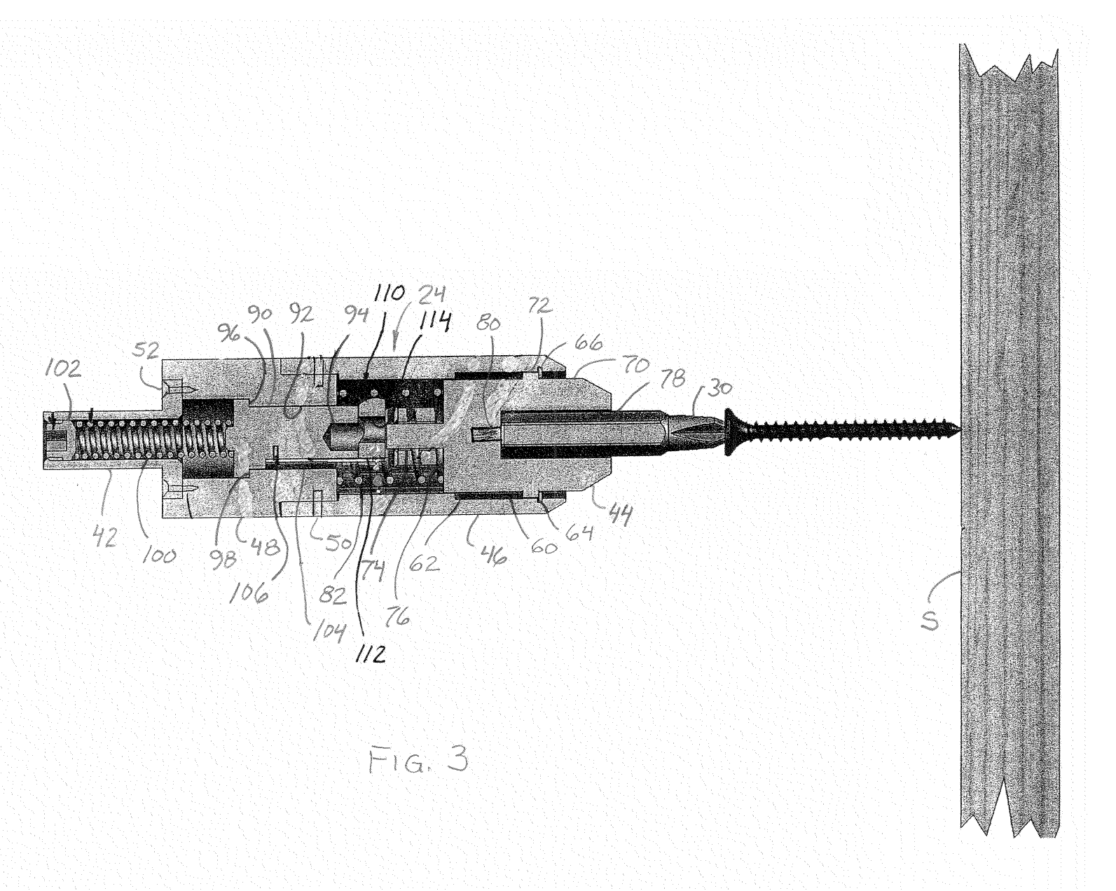

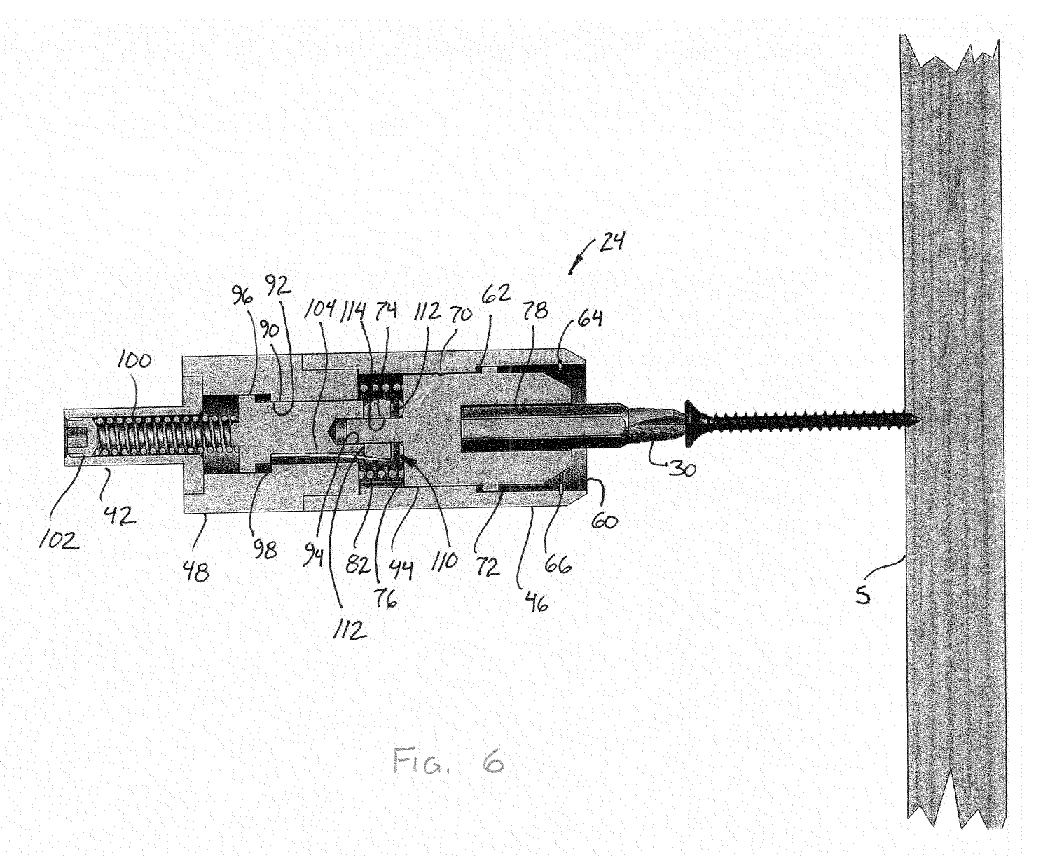

As shown in FIG. 2, the starter tool 24 includes a body or base, generally designated by 40, having a shank or mount 42 at one end for mounting the starter tool in the chuck 26 of the rotatable tool. The starter tool 24 has a chuck, generally designated by 44, opposite the mount 42 for holding the work bit 30. As further illustrated in FIG. 3, the base 40 of the starter tool 24 is formed from three annular components, a chuck holder 46, a striker holder 48, and the mount 42. In the embodiment illustrated in FIG. 3, the base components 46, 48, 42 are fastened together using screw fasteners 50, 52. An inner surface 60 of the chuck holder 46 includes a shoulder 62 and a retainer groove 64 for receiving an annular retainer 66 such as a split ring retainer. An outer surface 70 of the chuck 44 is sized and shaped to be received in the inner surface 60 of the chuck holder. The chuck 44 includes a flange 72 that engages the shoulder 62 and the retainer 66 to limit sliding movement of the chuck relative to the base 22. The chuck 44 moves in the base 40 between an extended position (as shown in FIG. 3), in which the chuck is positioned farther from the mount 42, and a retracted position (as shown in FIG. 6), in which the chuck is positioned closer to the mount. When in the extended position the flange 70 of the chuck 44 engages the retainer 66 and when in the retracted position the flange is positioned adjacent the shoulder 62. The chuck 44 includes a stem 74 extending toward the mount 42 from an anvil surface 76. The chuck 44 has an opening 78 for receiving the work bit 30. A magnet 80 provided in the opening 78 holds the bit in the opening. Although the chuck 44 in the illustrated embodiment is a magnetic chuck, the chuck may be of other types, such as a ball detent chuck or a mechanical collet chuck, without departing from the scope of the present invention. The chuck 44 is biased toward the extended position by a return spring 82 that pushes against the striker holder 48 component of the base 40. Although the illustrated return spring 82 is a coil compression spring, those skilled in the art will appreciate that the starter tool 24 may be reconfigured to use other types of springs.

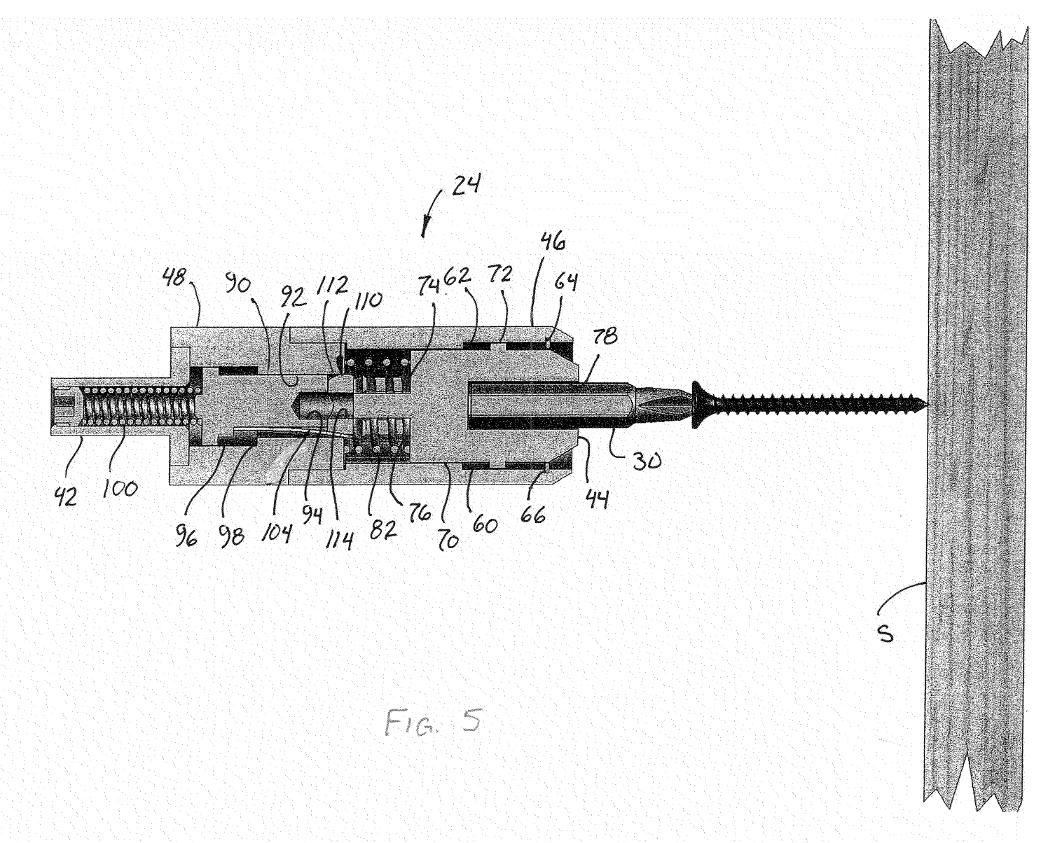

As further illustrated in FIG. 3, a hammer or striker 90 is mounted in an inner surface 92 of the striker holder 48. The striker 90 includes a hole 94 sized and shaped for receiving the stem 74 of the chuck 44. A flange 96 provided on the striker 90 engages a shoulder 98 formed in the inner surface 92 of the striker holder 48 for limiting sliding movement of the striker relative to the base 22. The striker 90 moves with respect to the base 22 between a striking position (as shown in FIG. 3), in which the striker is closer to the anvil surface 76 of the chuck 44 and a loaded position (as shown in FIG. 5), in which the striker is closer to the mount 42. The striker 90 is biased toward the striking position by a main or punch spring 100 that pushes against a plug or set screw 102 fastened inside the mount 42. Although the illustrated punch spring 100 is a coil compression spring, those skilled in the art will appreciate that the starter tool 24 may be reconfigured to use other types of springs. The cantilever spring 104 is fastened to a planer surface of the striker 90 with a screw fastener 106 for engaging a release, generally designated by 110, operatively and physically positioned between the striker and the anvil surface 76 of the chuck 44.

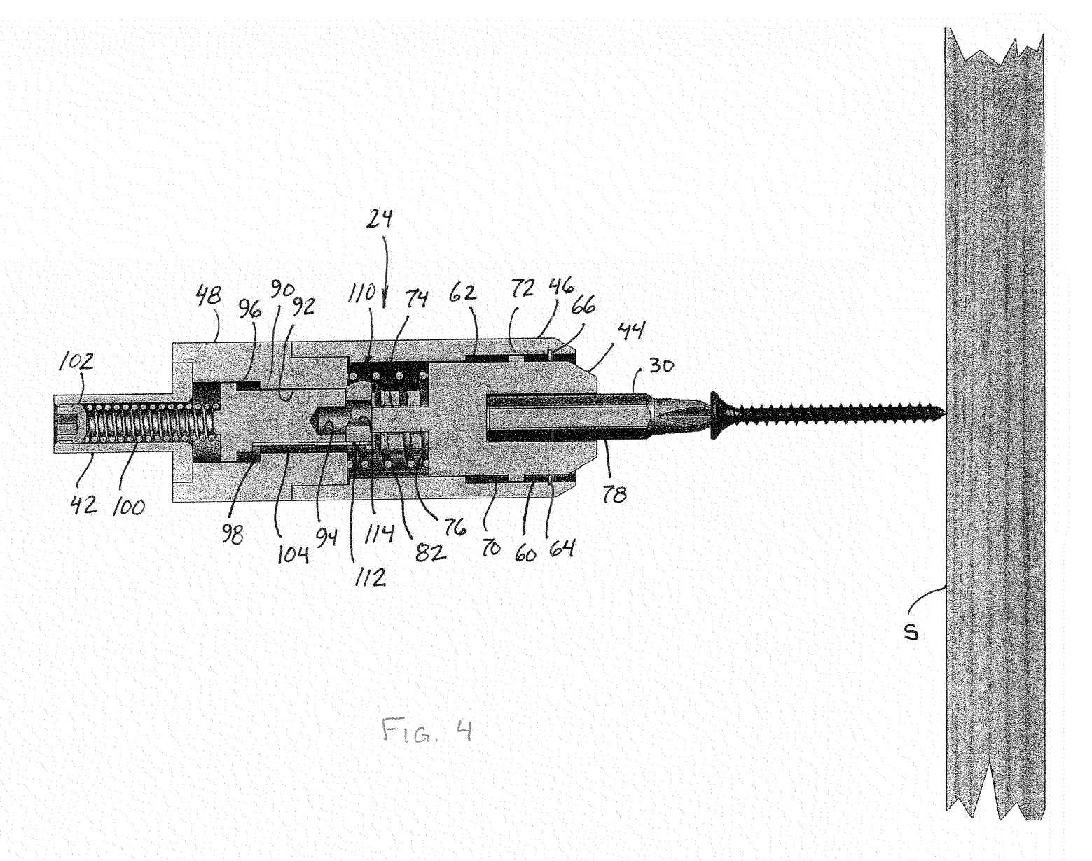

The release 110 includes a body 112 having an opening 114 and a sloped surface 116 that aligns the body opening with the chuck stem 74 and the striker hole 94 as the body travels from a partially compressed position as shown in FIG. 4 to a fully compressed or loaded position as shown in FIG. 5. Once the release 110 is in the loaded position as shown in FIG. 5, the release opening 114 is aligned with the striker hole 94 and the chuck stem 74. When the release opening 114, the striker hole 94, and the chuck stem 74 are aligned, the striker 90 is free to accelerate toward the chuck 44 under force generated by the punch spring 100, driving the release body 112 to impact the anvil surface 76 of the chuck to drive the work bit 30 toward the working surface S causing a starter dent to be formed in the working surface. As will be appreciated by those skilled in the art, the tool 24 components move from the position shown in FIG. 3, through the positions shown in FIG. 4 and FIG. 5, to the position shown in FIG. 6 by pushing the mount 42 toward the work bit 30, thereby compressing the return spring 82 and punch spring 110. Once the release impacts the chuck 44, pressure on the mount 42 may be released, allowing the return spring 82 and punch spring 110 to expand to return the tool 24 to the initial position shown in FIG. 3. As the tool returns to the initial position, the cantilever spring 104 moves the release body 112 so the body opening 114 is out of alignment with the chuck stem 74 and the striker hole 94. The materials and processes used to manufacture the starter tool 24 are well within the skill of those in the art and will not be described in further detail.

To use the combined tool 20, an operator pushes the tool toward the working surface S. As the tool 20 is pushed toward the surface S, the punch mechanism in the tool described above, drives the work bit 30 toward the working surface creating a starter dent. While maintaining pressure on the tool 20, the operator activates the tool to rotate the work bit 30.

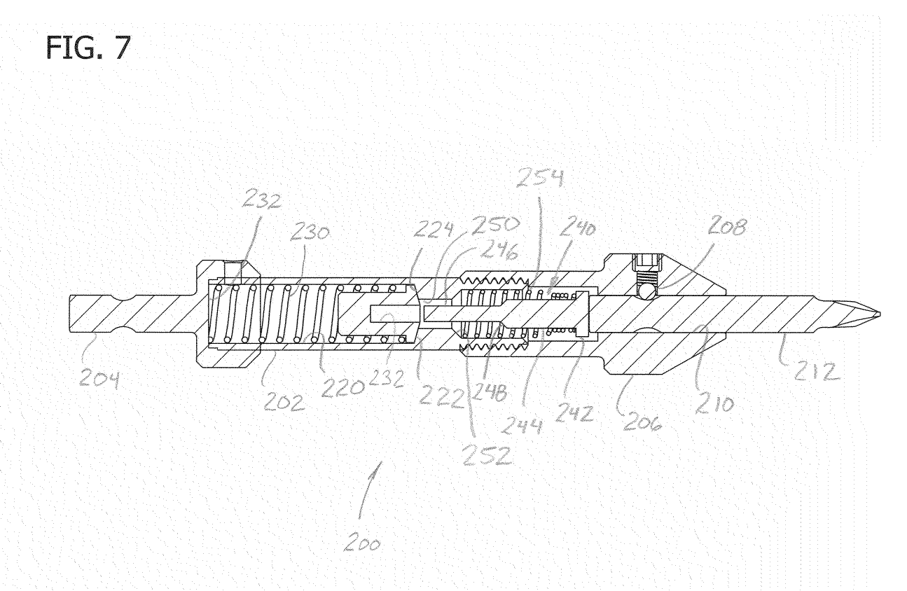

Referring to FIG. 7, a starter tool of a second embodiment of the present invention is designated in its entirety by the reference number 200. The tool 200 includes a base 202 having a mount 204. A chuck 206 is fastened to the base 202 opposite the mount 204 so the chuck is stationary with respect to the mount. The chuck 206 comprises a ball detent 208 that is biased toward a central opening 210 of the chuck sized and shaped for holding a work bit 212. The base 202 and chuck 206 form an interior 220 sized for holding a striker 222. The interior 220 includes a shoulder 224 for limiting sliding movement of the striker 222 relative to the base 202. The striker 222 moves with respect to the base 202 between a striking position, in which the striker touches the shoulder 224 and a loaded position, in which the striker is closer to the mount 204 and spaced from the shoulder. The striker 222 is biased toward the striking position by a main or punch spring 230 that pushes against a face 232 of the base 202 adjacent the mount 204. Although the illustrated punch spring 230 is a coil compression spring, those skilled in the art will appreciate that the starter tool 200 may be reconfigured to use other types of springs. The striker 222 also includes a central hole 232 facing the work bit 212.

As further shown in FIG. 7, a trigger or release, generally designated by 240, is mounted in the interior 220 immediately adjacent the work bit 212. The trigger 240 includes a head 242, a shaft 244 extending from the head, and a stem 246 extending from the shaft. The trigger 240 further includes a tapered section 248 between the shaft 244 and the stem 246. The stem 246 is sized to be received in the striker hole 232 and the shaft 244 is sized to be received in a necked portion 250 of the interior 220. As shown in FIG. 7, the necked portion 250 includes a tapered face 252 for leading the stem 246 and shaft 248 into the necked portion. The trigger 240 is biased toward the work bit 212 by a return spring 254 that engages the tapered face 252 and the head 242 of the trigger. Further, the spring 254 and/or the trigger head 242 are shaped to tilt the trigger 240 so the stem 246 is forced out of alignment with the striker hole 232.

When the work bit 212 is pushed against the working surface S, the ball detent 208 releases the work bit so it slides in the chuck opening 210 toward the mount 204. The work bit 212 pushes the trigger 240 against the force of the return spring 254 toward the striker 222. Because the stem 246 and the striker hole 232 are not aligned, the trigger 240 forces the striker 222 toward the mount 204 against the force of the punch spring 230. When the tapered portion of the trigger 240 meets the tapered face 252, the stem 246 is centered in the neck portion 250 so the stem is aligned with the striker hole 232. As the stem 246 enters the striker hole 232, the striker 222 is accelerated forward until an end of the striker hole hits an end of the striker stem. This impact drives the work bit 212 toward the working surface S forming a starter dent in the working surface. The operator can continue to push the work bit 212 against the working surface S until the striker 222 bottoms out against the face 232 of the base 202. Thus, substantial force may be applied to the work bit 212 by the operator when the tool is activated to rotate the work bit. As the other operation and features of the second embodiment will be apparent to those skilled in the art, they will not be described in further detail. As will apparent to those skilled in the art, the springs, releases, triggers, and strikers of the starter tools described above constitute punch mechanisms for driving the work bits toward the working surfaces.

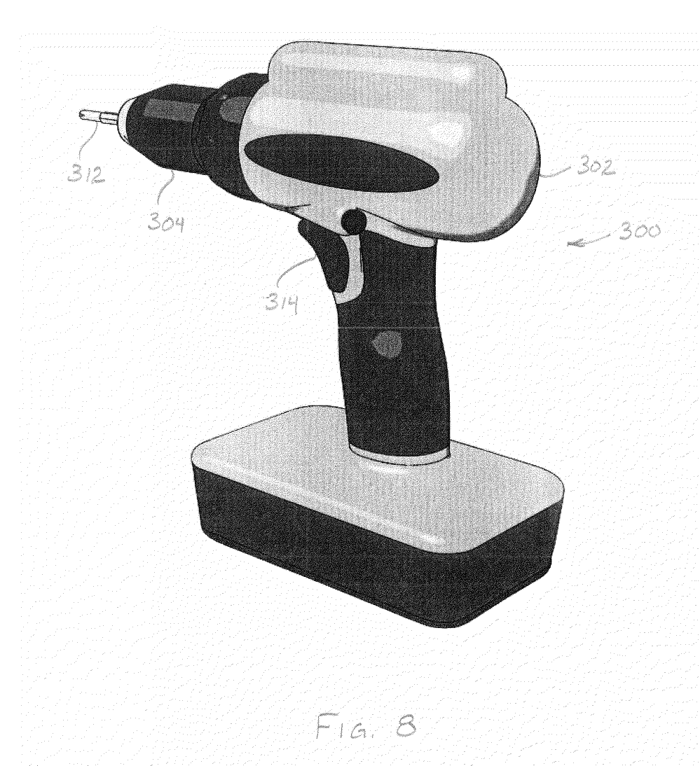

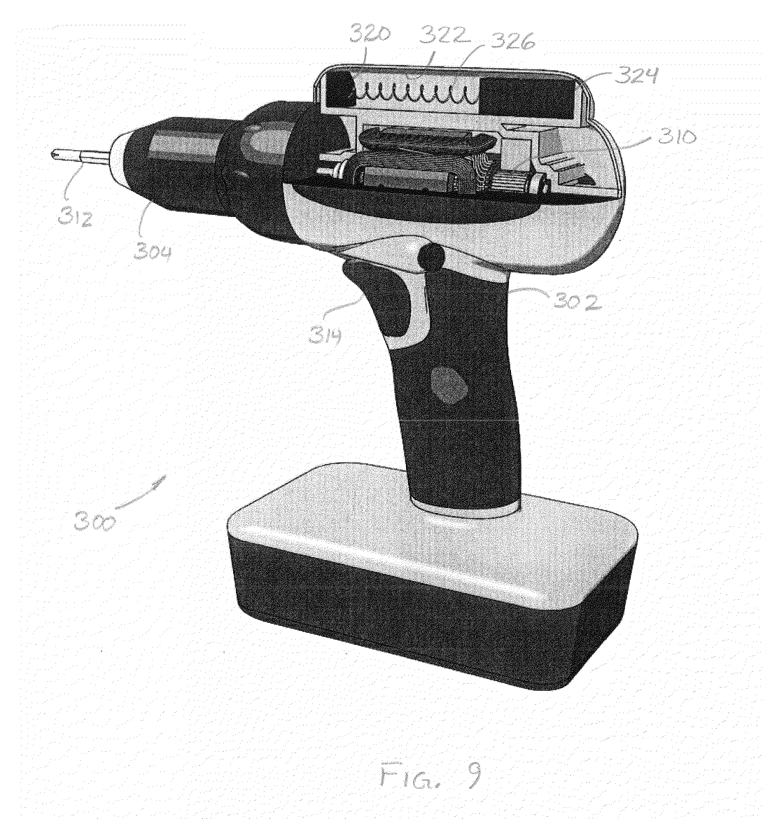

Referring to FIG. 8, a tool of a third embodiment of the present invention is designated in its entirety by the reference number 300. The tool 300 includes a pistol grip housing 302 having a chuck 304 rotatable mounted on the housing. Although the chuck may be of other types without departing from the scope of the present invention, in one embodiment, the chuck 304 is a mechanical collet chuck. The chuck 304 is selectively rotated by a motor 310 as shown in FIG. 9 to rotate a work bit 312 held in the chuck. A trigger 314 provided on the housing 302 energizes the motor 310 to rotate the chuck 304. As further illustrated in FIG. 9, a hardened anvil surface 320 is mounted on the housing 302 at a forward end of a tubular cavity 322. A striker 324 is slidably received in the cavity 322 so it can move between an striking position in which the striker engages the anvil surface 320 and a loaded position in which the striker is spaced from the anvil surface. A spring 326 engages the striker 324 to bias the striker toward the loaded position shown in FIG. 9. A coil 330 of conductive wire surrounds the striker 324. A button 332 on the housing 302 is provided to energize the coil 330 causing an electromagnetic field to drive the striker 324 forward toward the anvil surface 320. When the striker 324 impacts the anvil surface 320, the work bit 312 is forced toward the working surface forming a starter dent. As those skilled in the art will appreciate, the coil 326 and striker 324 act as a solenoid. It should be noted that the striker 324 need not be axially aligned with the work bit 312 to impart an axial force on the bit. As will apparent to those skilled in the art, the solenoid and anvil surface described above constitute a punch mechanism for driving the work bit toward the working surface.

As will be appreciated by those skilled in the art, the embodiments of the invention described above permit a starter dent to be formed with one tool, during a single operation, using one hand. Further, the embodiments of the invention permit less expensive non-self-starting-tip sheet metal screws to be used in certain applications where they were not effective in the past.

Having described the invention in detail, it will be apparent that modifications and variations are possible without departing from the scope of the invention defined in the appended claims.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A starter tool for use with a rotatable tool comprising:
a base having a mount adapted to connect to the rotatable tool;
a chuck adapted to hold a work bit moveably connected to the base for movement with respect to the base between an extended position, in which the chuck is positioned farther from the mount, and a retracted position, in which the chuck is positioned closer to the mount, the chuck being biased toward the extended position and having an anvil surface;
a striker mounted on the base for movement with respect to the chuck between a striking position, in which the striker is closer to the anvil surface, and a loaded position, in which the striker is farther from the anvil surface, the striker being biased toward the striking position; and
a release operatively positioned between the striker and the anvil surface of the chuck permitting the striker to move from the loaded position toward the striking position when the chuck reaches the retracted position thereby allowing the striker to provide an impact force on the anvil surface of the chuck to drive the work bit toward a working surface.

2. A starter tool as set forth in claim 1 wherein the release is physically positioned between the striker and the anvil surface of the chuck.

3. A starter tool as set forth in claim 2 wherein:
the chuck includes stem extending toward the striker;
the striker includes an hole sized and shaped for receiving the stem; and
the release includes a body having an opening that is biased out of alignment with the chuck stem and the striker hole when the chuck is in the extended position preventing the chuck stem from entering the striker hole, the body opening moving into alignment with the chuck stem and the striker hole as the chuck moves toward the retracted position allowing the striker to impact the anvil surface of the chuck driving the work bit toward a working surface.

4. A starter tool as set forth in claim 3 wherein the release includes a cantilever spring mounted on the striker for biasing the body opening out of alignment with the chuck stem and the striker hole.

5. A starter tool as set forth in claim 3 wherein:
the base includes an opening sized for slidingly receiving the striker and the release body; and
the release body includes a sloped surface that aligns the body opening with the chuck stem and the striker hole as the body enters the base opening.

6. A starter tool as set forth in claim 1 wherein the chuck comprises a ball detent.

7. A starter tool as set forth in claim 1 further comprising a coil compression spring positioned between the base and the chuck for biasing the chuck toward the extended position.

8. A starter tool as set forth in claim 1 further comprising a coil compression spring positioned between the base and the striker for biasing the striker toward the striking position.

9. A tool comprising:
a housing;
a chuck rotatably mounted on the housing adapted to hold a work bit for rotating the work bit;
an anvil surface mounted on the housing
a striker moveably mounted on the housing for movement between a striking position, in which the striker is closer to an anvil surface fixed against axial movement with respect to the housing, and a loaded position in which the striker is farther from an anvil surface; and
a punch mechanism mounted on the housing operatively positioned between striker and the anvil surface and selectively driving the striker toward the anvil surface to drive the work bit toward a working surface.

10. A rotatable tool as set forth in claim 9 wherein the punch mechanism comprises a selectively energizable coil positioned to drive the striker toward the anvil surface to drive the work bit toward the working surface.

11. A rotatable tool as set forth in claim 10 wherein the punch mechanism comprises a switch for selectively delivering electricity to the coil.

12. A rotatable tool as set forth in claim 9 wherein the chuck comprises a collet adapted to hold the work bit.

13. A rotatable tool as set forth in claim 9 further comprising a motor mounted on the housing and operatively connected to the chuck for rotating the chuck

14. A rotatable tool as set forth in claim 9 wherein:
the striker travels along a line; and
the line is non-co-linear with an axis of the chuck.

15. A starter tool selectively connectible to a rotatable tool, said starter tool comprising:
a base having a mount adapted to connect to the rotatable tool;
a chuck rotatably mounted on the base and adapted to hold a work bit; and
a punch mechanism operatively connected to the work bit and selectively providing an impact force on the work bit to drive the work bit toward a working surface.

16. A starter tool as set forth in claim 15 wherein the punch mechanism comprises a striker mounted on the base for movement with respect to the base between a striking position, in which the striker is closer to the chuck, and a loaded position, in which the striker is farther from the chuck, the striker being biased toward the striking position.

17. A starter tool as set forth in claim 16 wherein the punch mechanism comprises a release operatively positioned between the striker and the chuck permitting the striker to move from the loaded position toward the striking position when the chuck reaches a retracted position thereby allowing the striker to provide an impact force on the chuck to drive the work bit toward a working surface.

18. A starter tool as set forth in claim 17 wherein the release comprises a body biased toward a blocking position in which the body prevents the striker from moving to the striking position.

19. A starter tool as set forth in claim 18 wherein the release includes a spring engaging the body for biasing the body to the blocking position.

20. A starter tool as set forth in claim 19 wherein the body is selectively moveable out of the blocking position permitting the striker to move to the striking position.

21. A starter tool as set forth in claim 16 further comprising a spring positioned between the base and the chuck for biasing the chuck toward the loaded position.

22. A starter tool as set forth in claim 16 further comprising a spring positioned between the base and the striker for biasing the striker toward the striking position.

23. A starter tool as set forth in claim 16 wherein the punch mechanism comprises a release operatively positioned between the striker and the work bit permitting the striker to move from the loaded position toward the striking position when the work bit reaches a retracted position thereby allowing the striker to provide an impact force on the work bit to drive the work bit toward a working surface.

24. A starter tool as set forth in claim 23 wherein:
the striker includes a hole facing the chuck; and
the release includes a trigger having a stem facing the striker, the stem being biased out of alignment with the striker hole, the trigger engaging the base to center the stem and align the stem with the striker hole as the work bit moves toward the retracted position.

25. A starter tool for use with a rotatable tool comprising:
a base having a mount adapted to connect to the rotatable tool;
a chuck adapted to hold a work bit so the work bit moves with respect to the base between an extended position, in which the work bit is positioned farther from the mount, and a retracted position, in which the work bit is positioned closer to the mount, the work bit being biased toward the extended position;
a striker mounted on the base for movement with respect to the chuck between a striking position, in which the striker is closer to the chuck, and a loaded position, in which the striker is farther from the chuck, the striker being biased toward the striking position; and
a release operatively positioned between the striker and the work bit permitting the striker to move from the loaded position toward the striking position when the work bit reaches the retracted position thereby allowing the striker to provide an impact force on the work bit to drive the work bit toward a working surface.

26. A starter tool as set forth in claim 25 wherein:
the striker includes a hole facing the chuck; and
the release comprises a trigger positioned between the working bit and the striker having a stem extending toward the striker sized and shaped for receipt in the striker hole, said trigger being movable between a loaded position in which the stem is out of alignment with the striker hole and a striking position in which the stem is aligned with the striker hole, the trigger being biased toward the loaded position and moving toward the striking position as the work bit moves toward the retracted position thereby allowing the striker to provide an impact force on the work bit driving the work bit toward a working surface.

27. A starter tool as set forth in claim 26 wherein the trigger includes a tapered section and the base includes a central opening adapted to receive the taper section of the trigger to align the stem with the striker hole.
